(19) United States
(12) Patent Application Publication
(10) Pub. No.: US 2011/0272906 A1
(43) Pub. Date: Nov. 10, 2011

(54) Swingarm Suspension

(76) Inventors: David R. Hall, Provo, UT (US); Stephen Hall, Sandy, UT (US)

(21) Appl. No.: 12/774,083

(22) Filed: May 5, 2010

(51) Int. Cl. B60G 3/14

(52) U.S. Cl. 280/124.116

(57) ABSTRACT

In one aspect of the present invention, a vehicle comprises a frame comprising a front portion and a rear portion, with two front wheels steerably attached to the front portion, a swing arm connected to the rear portion of the frame at first and second pivots separated by a first distance, the pivots comprising a common axis of rotation, and a drive wheel attached to a distal end of the swing arm, the common axis of rotation and the distal end of the swing arm being separated by a second distance, wherein the first distance is greater than the second distance.

### BACKGROUND OF THE INVENTION

This invention relates to rear suspension systems for use on wheeled vehicles, particularly vehicles having a single rear drive wheel. Such suspension systems are disclosed in the prior art.

U.S. Pat. No. 6,247,796 to Tsutsumikoshi, which is herein incorporated by reference for all that it contains, discloses the following: In a motorcycle in which an engine unit is mounted to a motorcycle body and a power transmission unit coupled to the engine unit is arranged to the motorcycle body to be swingable through a pivot shaft, a rear wheel suspension system is formed so as to include the power transmission unit, a pair of arm members disposed to lateral side portions of the motorcycle body in parallel to each other, and connection members connecting both end portions of the arm members. One of the arm members constitutes the power transmission unit which has an inner hollow portion in which a power transmission member is accommodated and has a structure dividable into lateral two parts forming an arm base section and a cover section.

U.S. Pat. No. 7,121,570 to Parker, which is herein incorporated by reference for all that it contains, discloses a rear single-sided swingarm suspension for a motorcycle that includes a single-sided swingarm that has an axle bearing assembly pivotably connected to the rearward end thereof for swinging motion in a plane parallel to the plane of travel of the swingarm. A cantilevered wheel axle is journalled in the axle bearing assembly and is affixed to the rear wheel. A control arm, which is shorter than the swingarm, extends generally parallel to the swingarm and is pivotably connected to the motorcycle frame at a point rearward of the forward end of the swingarm. The axle bearing assembly also is pivotably attached to the rear end of the control arm. The wheel axle is journalled in the axle bearing assembly at a point rearward of the rear end of the swing arm and on the opposite side of the swingarm from the control arm. The axle bearing assembly may include an axle housing having a splined tube extending generally parallel to the swingarm, and an upright member having a cooperably splined cylinder which receives the splined tube, so as to allow linear movement and securing of the position of the rear wheel axle with respect to the axis of the swingarm and thereby select the drive chain tension. The suspension results in the path of travel of the wheel axle during swingarm motion being more nearly vertical, thereby better isolating propulsion drive forces on the wheel from weight loads and road shocks.

U.S. Pat. No. 5,295,702 to Buell, which is herein incorporated by reference for all that it contains, discloses a rear suspension system for a two wheel cycle such as a bicycle or motorcycle having a vertically pivotable rear frame assembly to which the rear wheel is mounted. The rear frame assembly includes a primary swingarm which extends downwardly and rearwardly from a pivotable connection on the main frame. A rear wheel fitment is attached at the rear of this primary swingarm. A secondary swingarm is also fixed to the rear wheel fitment, and extends forwardly from the fitment at an angle below to the primary swingarm. The secondary swingarm mounts to the main frame via an attachment which has capability of permitting a change in vertical and horizontal location of the attachment point of the secondary swingarm, necessitated for rotation of the rear frame assembly about the main swingarm pivotable connection, while still providing lateral rigidity. Both swingarms pass along one side of the cycle only, with the rear wheel being mounted in a cantilever fashion from the rear wheel fitment which is also on the same one side. The system provides convenience in wheel and tire access, and also provides very high lateral and torsional rigidity in passing lateral loads from the rear tire contact patch to the main frame, due to the vertical spacing between the frame connections of the primary and secondary swingarms.

### BRIEF SUMMARY OF THE INVENTION

In one aspect of the present invention, a vehicle comprises a frame with a front portion and a rear portion, with two steerable front wheels connected to the front portion of the frame. A swing arm is connected to the rear portion of the frame at two pivots separated by a first distance, the pivots comprising a common axis of rotation, and a drive wheel is attached to a distal end of the swing arm. The common axis of rotation of the pivots and the distal end of the swing arm are separated by a second distance. The first distance greater than the second distance.

The drive wheel may be in mechanical communication with a rotating drive shaft disposed proximate the rear portion of the frame. The rotating drive shaft may comprise an axis of rotation coaxial with the common axis or rotation of the pivots. A transmission may be disposed between the pivots, such that the transmission output shaft is located coaxial with the axis of rotation of the pivots. The transmission may be the constantly variable type, or a transmission with discrete gear ratios comprising planetary gears, helical gears, or both.

The drive wheel may be in mechanical communication with the rotating drive shaft through a chain and sprockets, a belt and pulleys, or a geared intermediate shaft. The rotating drive shaft may be driven by and internal combustion engine. In some embodiments, the internal combustion engine may be located proximate the rear portion of the frame. The engine may comprise a two-stroke power cycle or a four-stroke power cycle. In other embodiments, the rotating drive shaft may be driven by an electric motor.

A spring and damper mechanism may be disposed between a point on the frame, and a point on the swing arm intermediate the pivot axis and the distal end. In some embodiments, a mechanical linkage may be disposed intermediate the spring and damper and the intermediate point on the swing arm.

The vehicle may comprise an enclosed passenger compartment with a deformation resistant roll cage disposed about the passenger compartment. The vehicle may comprise a center of gravity located below a plane formed by the rotational axes of the front wheels and rear wheel. The center of gravity may be located forward of a midpoint of a line between and perpendicular to the wheel rotational axes.

### BRIEF DESCRIPTION OF THE DRAWINGS

FIG. 1 is a perspective view of an embodiment of a vehicle.

FIG. 2 is a perspective view of another embodiment of a vehicle.

FIG. 3 is an orthogonal view of an embodiment of a swing arm.

FIG. 4a is an orthogonal view of another embodiment of a vehicle.

FIG. 4b is an orthogonal view of another embodiment of a vehicle.

FIG. 5 is a perspective view of another embodiment of a swing arm.

FIG. 6 is a perspective view of another embodiment of a swing arm.

FIG. 7 is a perspective view of another embodiment of a swing arm.

FIG. 8 is an orthogonal view of another embodiment of a swing arm.

FIG. 9 is a perspective view of another embodiment of a vehicle.

FIG. 10 is an orthogonal view of another embodiment of a vehicle.

### DETAILED DESCRIPTION OF THE INVENTION AND THE PREFERRED EMBODIMENT

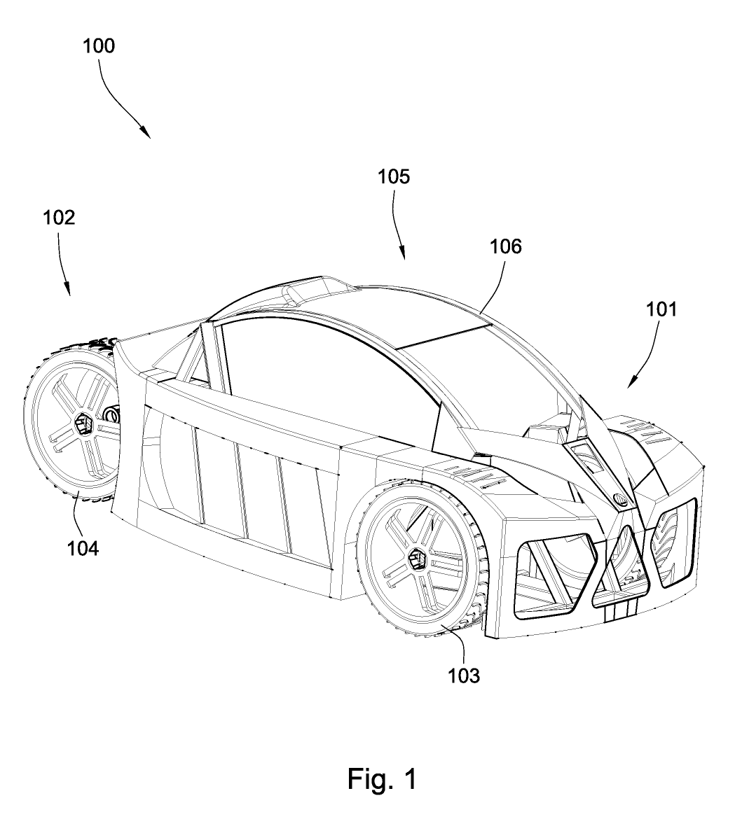

Referring now to the figures, FIG. 1 discloses an embodiment of a vehicle 100. The vehicle 100 comprises a front portion 101 and a rear portion 102. Two steerable front wheels 103 are connected to the front portion 101 and a single rear wheel 104 is connected to the rear portion 102. The vehicle 100 comprises an enclosed passenger compartment 105, surrounded by a deformation resistant roll cage 106. In the event of collision or rollover, the roll cage 106 may protect an operator of the vehicle from injury.

The enclosed passenger compartment may comprise a seat that places an operator in a substantially recumbent position. The passenger compartment may also comprise stowage space for luggage or other cargo. The passenger compartment may comprise convenience or entertainment equipment such as an audio system, climate control with heater and air conditioning, a GPS navigation system, or other features.

The front wheels may be connected to the frame by a double wishbone type arrangement, a control arm and strut arrangement, or other method. The front wheels may steer in response to inputs from an operator through a rack and pinion or worm gear and pinion steering system.

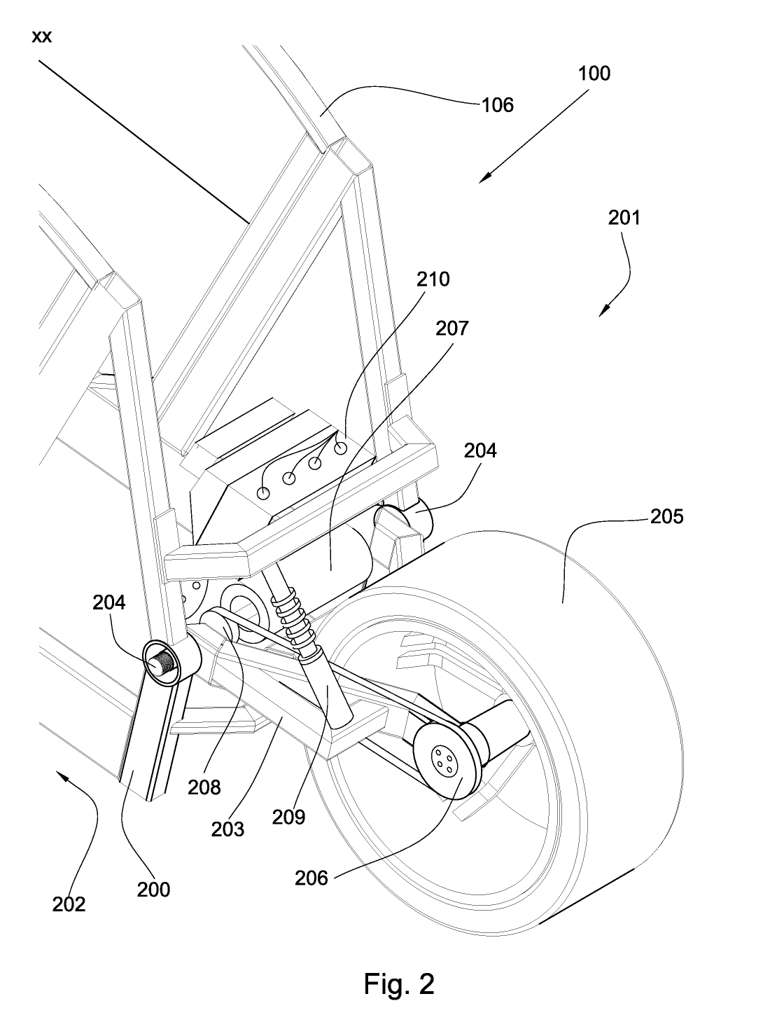

FIG. 2 discloses another embodiment of a vehicle 100. In this embodiment, the vehicle 100 comprises a frame 200 with a rear portion 201 and a front portion 202, a roll cage 106 and a swing arm 203. The swing arm 203 connects to the rear portion of the frame 200 at two pivots 204. A drive wheel 205 is attached to a distal end 206 of the swing arm 203. The two pivots 204 share a common axis of rotation.

The frame 200 may be constructed from steel, aluminum alloy, magnesium, composite materials such as fiberglass or carbon fiber, other materials, or combinations thereof. The vehicle may also comprise exterior body panels made from aluminum, fiberglass, carbon fiber, or other materials. The body panels may be stressed structural members or may be unstressed.

The swing arm 203 may comprise bearings or bushings at the pivots 204. The bearings or bushings may comprise ball bearings, roller bearings, needle bearings, tapered roller bearings, bronze or nylon bushings, or other bearing or bushing designs. The swing arm may be constructed from steel, aluminum alloy, other metal alloys, composite materials, or combinations thereof. In some embodiments, the swing arm may comprise hydroformed aluminum tubing.

In this embodiment, the vehicle 100 comprises an internal combustion engine 210. The engine 210 may comprise a four stroke power cycle and a volumetric displacement of between 500 and 2000 cubic centimeters with multiple cylinders in an inline arrangement. The internal combustion engine may be connected to a transmission 207 comprising an output shaft 208. The output shaft 208 may comprise an axis of rotation coaxial with the axis of rotation of the pivots 204. The output shaft may be mechanically connected to the drive wheel through a chain and sprockets. The transmission may be a constantly variable transmission, a transmission with discrete gear ratios using planetary or helical gears, a hydrostatic transmission, or other transmission system. In some embodiments, the transmission comprises a sequential shift manual transmission comprising straight cut gears.

In other embodiments, the vehicle may comprise an internal combustion engine having a single cylinder, multiple cylinders in a V, flat, or inline arrangement, a two stroke power cycle, or a compression ignition power cycle. In other embodiments, the vehicle may comprise a rotary engine, a turbine engine, or a fuel cell and electric motor. The engine may consume gasoline, organic or mineral alcohol, Diesel fuel, or other mineral or organic fuels.

In some embodiments, the vehicle may comprise a hybrid powertrain comprising an internal combustion engine, an energy accumulator and an energy dissipater. The energy accumulator may comprise a battery or a pressurized hydraulic tank, and the energy dissipater may comprise an electric motor or a hydraulic motor.

A spring and damper mechanism 209 may be connected between a point on the frame 200 and a point on the swing arm 203 located between the pivots and the distal end. The spring may comprise a pressurized air or other gas spring, or a coil spring or leaf spring made from material such as a steel alloy or titanium alloy.

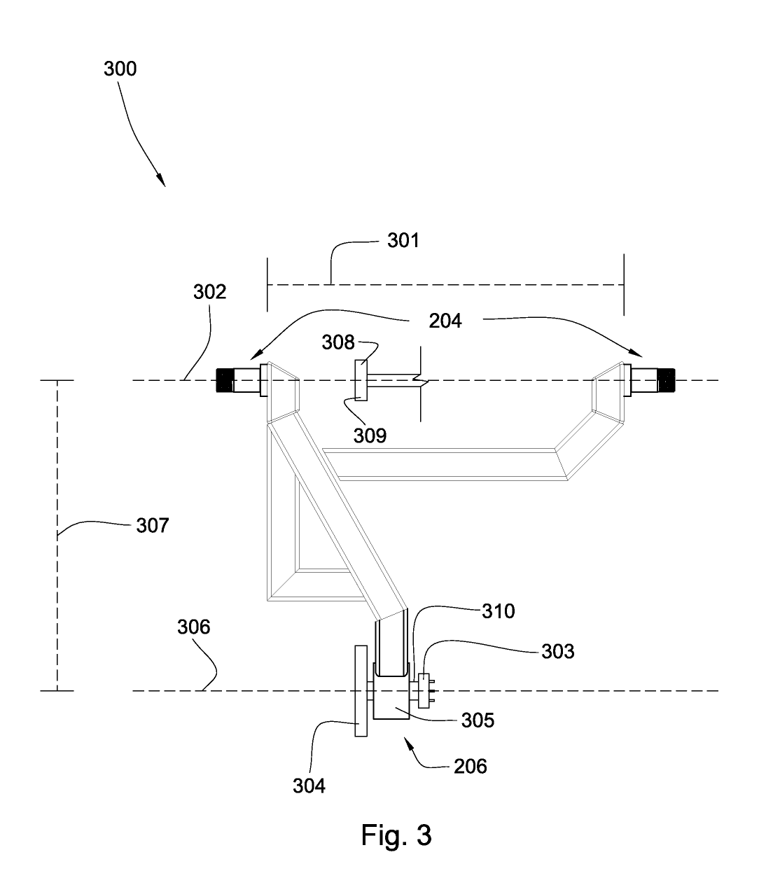

FIG. 3 discloses an embodiment of a swing arm 300 comprising two pivots 204 and a distal end 206. The pivots 204 are separated by a first distance 301 and rotate about a common axis of rotation 302. The distal end 206 may comprise a hub 303 for attaching a drive wheel. The hub may be connected to a driven sprocket 304 through an axle 310 that passes through a bearing shell 305 at the distal end 206 of the swing arm. The axle 310 may rotate in tapered roller bearings or another appropriate bearing arrangement. The axle 310 may comprise an axis of rotation 306. A second distance 307 is measured between the axis of rotation 302 of the pivots and the axis of rotation 306 of the axle. The dimension of the first distance 301 is greater than the dimension of the second distance 307. The first distance 301 may allow room for at least a portion of a transmission assembly to be located substantially between the pivots 204. In this embodiment, locating a transmission assembly in this manner allows an output shaft 308 of the transmission to have substantially the same axis of rotation as the axis of rotation 302 of the pivots 204.

The output shaft 308 may comprise a drive sprocket 309, and a chain may connect the drive sprocket to the driven sprocket 304 connected to the axle and hub 303. The drive sprocket 309 and the driven sprocket 304 may comprise different diameters to allow a torque multiplication between the output shaft and the axle. The ratio between the drive and driven sprockets may be chosen to maximize efficiency, to maximize acceleration, or to maximize top speed, or a compromise between acceleration performance, top speed, and efficiency may be chosen. In this embodiment, the driven sprocket may be easily removed from the axle to allow adjustments to the gear ratio with a minimum of mechanical disassembly.

The geometry of the swing arm 203 may be chosen to minimize torsional or lateral deflection of the distal end 206 with respect to the pivots 204 due to loads imposed by the rear wheel and the spring and damper mechanism. In some embodiments, the swing arm may comprise geometry that tapers from a relatively large cross section proximate the pivots 204 to a relatively smaller cross section proximate the distal end 206.

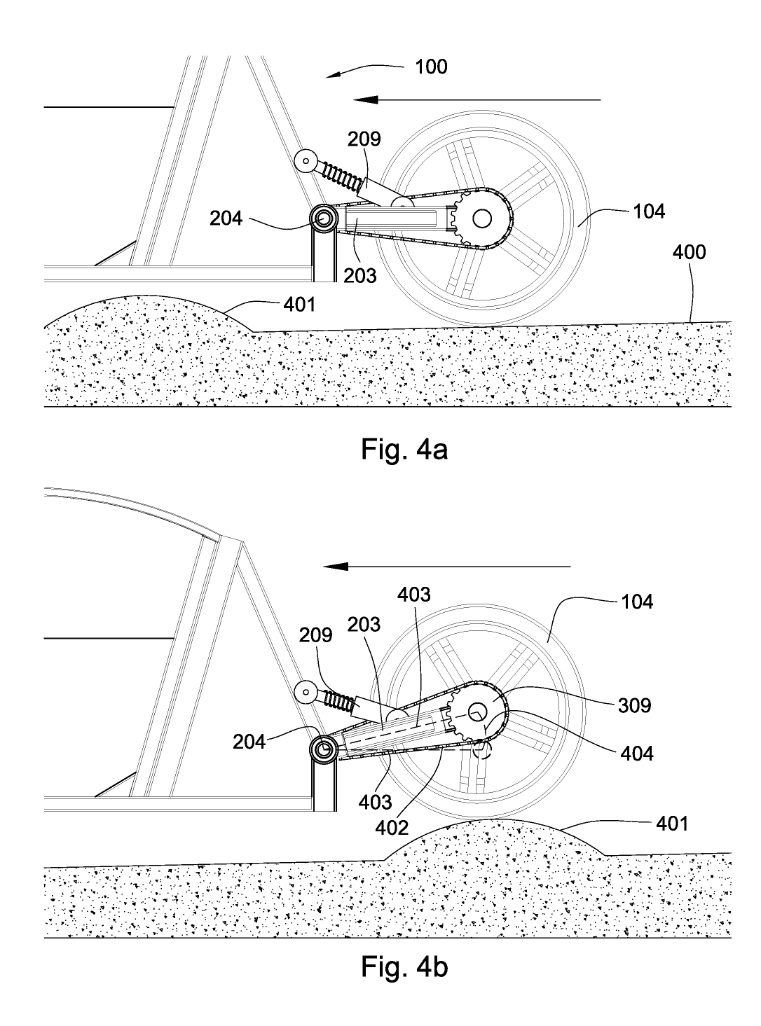

FIG. 4a shows a vehicle 100 traversing a roadway 400. The roadway comprises one or more surface irregularities 401. The vehicle 100 comprises a rear wheel 104, a swing arm 203, a spring and damper mechanism 209, and swing arm pivots 204.

In FIG. 4b, the rear wheel 104 contacts the surface irregularity 401, and the swing arm 203 rotates about pivots 204, compressing the spring and damper mechanism 209 allowing rear wheel 104 to move upwards, thus isolating the body of the vehicle 100 from the irregularity.

In this embodiment, the vehicle 100 comprises a rotating output shaft with a drive sprocket connected to a driven sprocket 309 through a chain 402. The rotating output shaft shares a common axis of rotation with the pivots 204. As the swing arm rotates about pivots 204, the distance 403 between the output shaft and the drive sprocket 309 remains the same. Thus, the tension in the chain 402 remains constant throughout the arc of swing arm travel 404. This may eliminate the need for a chain tensioner thus simplifying the design and manufacture of the vehicle.

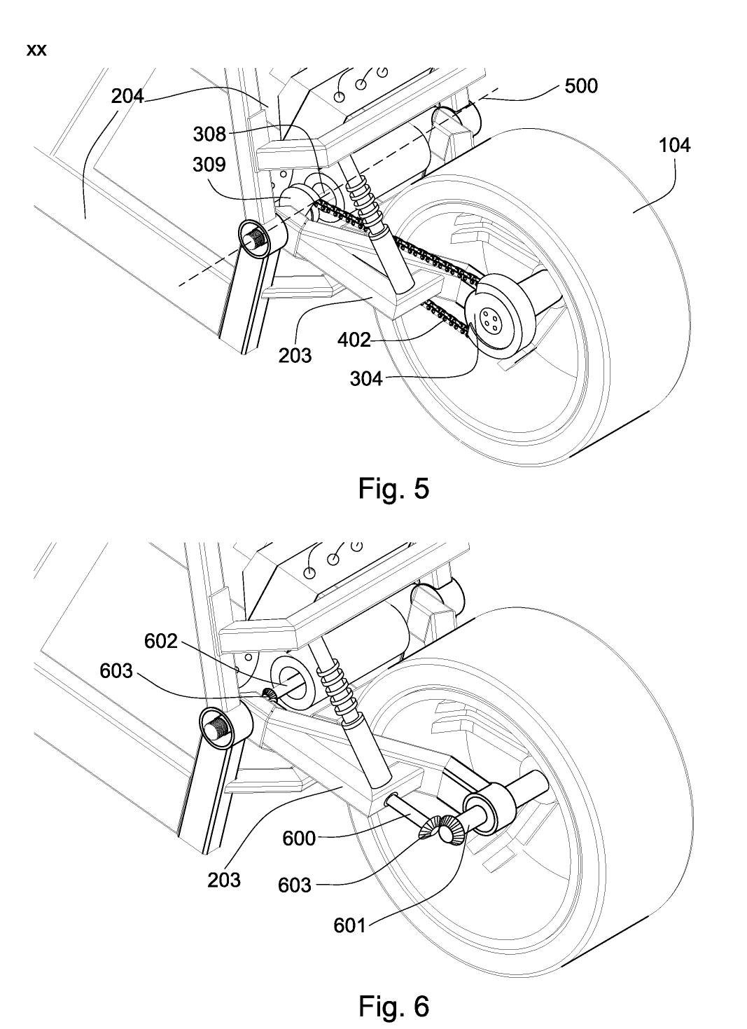

FIG. 5 discloses another embodiment of a swing arm 203 comprising pivots 204. A rear wheel 104 is attached to the swing arm 203, and a driven sprocket 304 is in mechanical communication with the rear wheel 104. A chain 402 connects the driven sprocket 304 with a drive sprocket 309. Drive sprocket 309 is connected to an output shaft 308 having an axis of rotation 500 coaxial with an axis of rotation of the pivots 204.

FIG. 6 discloses another embodiment of a swing arm 203 comprising an intermediate drive shaft 600. The intermediate drive shaft 600 may be mechanically connected to an axle 601 and an output shaft 602 by bevel gears 603. In some embodiments, the bevel gears are enclosed in a housing with lubrication. In other embodiments, the bevel gears may be replaced by universal joints, constant velocity joints, or other torque transmission joints. An intermediate shaft may provide benefits compared to a chain, including low maintenance and low noise.

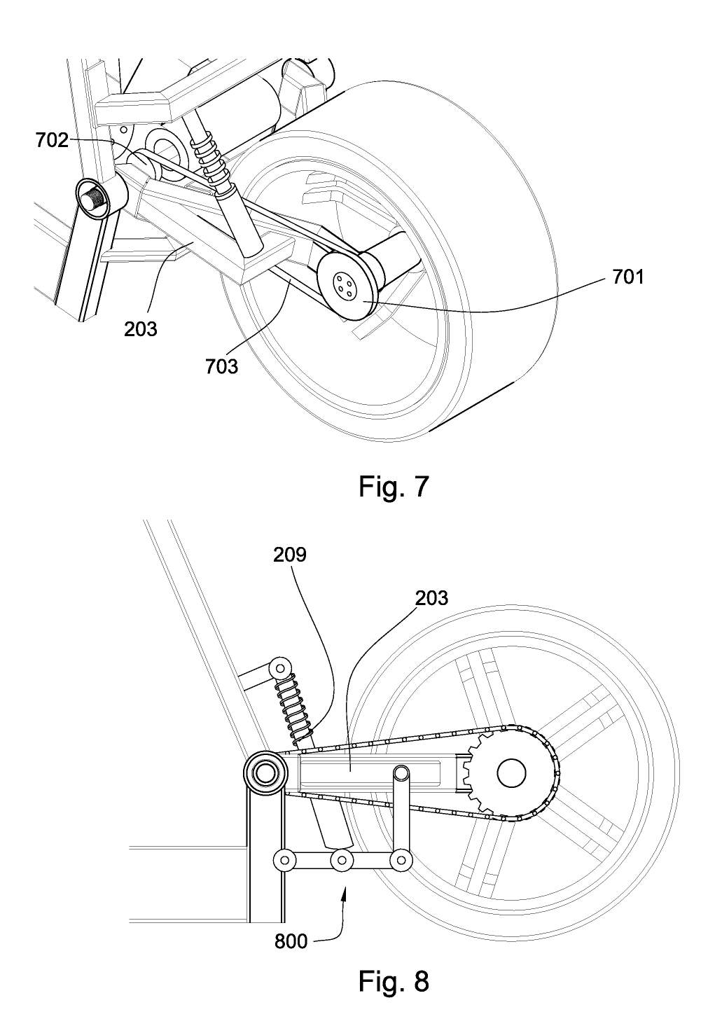

FIG. 7 discloses another embodiment of a swing arm 203. In this embodiment, a driven pulley 701 and a drive pulley 702 are connected by a continuous drive belt 703. The drive belt 703 may be made from natural or silicon rubber reinforced with steel belts, carbon fiber, nylon, fiberglass, or other flexible materials that comprise a sufficiently high modulus of elasticity. A belt may provide several advantages compared to a chain, including eliminating the need for lubrication, lower noise levels, and less weight.

FIG. 8 discloses another embodiment of a swing arm 203, comprising a spring and damper mechanism 209. The spring and damper mechanism may be connected to the swing arm 203 through a mechanical linkage 800. The mechanical linkage may allow the spring and damper to be compressed at a non-constant rate relative to the movement of the swing arm 203. In this embodiment, an effective leverage ratio of the swing arm acting on the spring and damper may be greater when the spring and damper are lightly compressed and lesser when the spring and damper are highly compressed. This may allow high suspension sensitivity for small irregularities while preventing the spring and damper from compressing completely on large or severe irregularities.

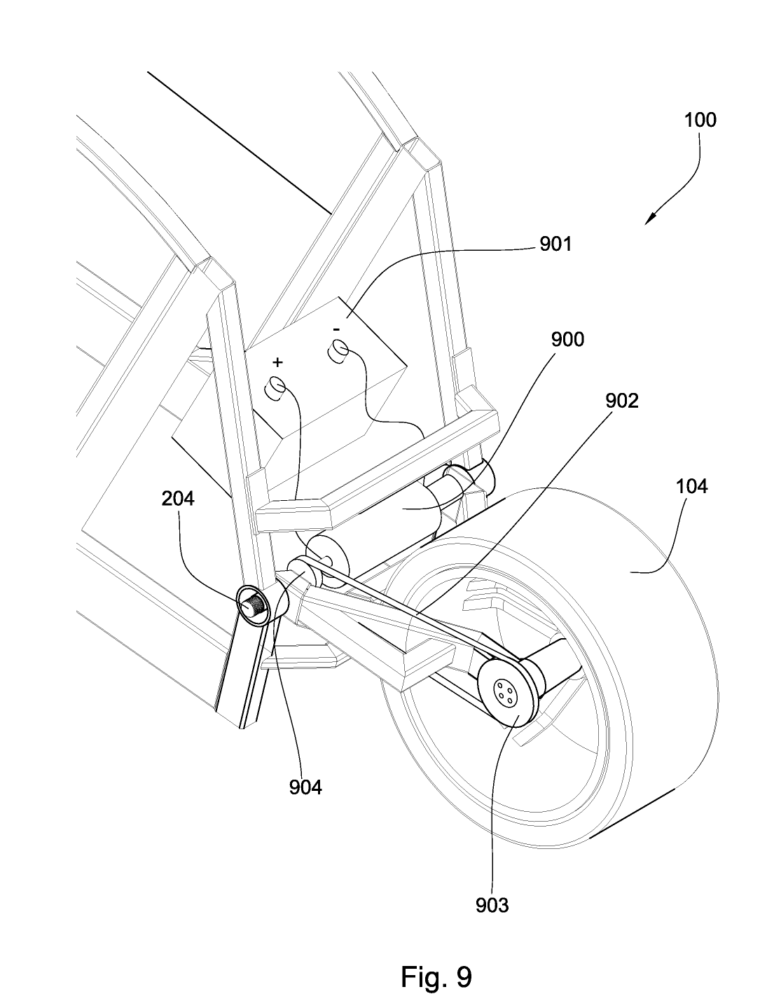

FIG. 9 discloses another embodiment of a vehicle 100. In this embodiment, vehicle 100 comprises an electric motor 900 and one or more batteries 901. Electric motor 900 is connected to a rear wheel 104 through a belt or chain 902 and pulleys or sprockets 903 and 904. In this embodiment, an axis of rotation of the electric motor shaft is coaxial with an axis of rotation of swing arm pivots 204. The batteries may comprise lead acid, alkaline metals, lithium ion, lithium polymer, or other materials.

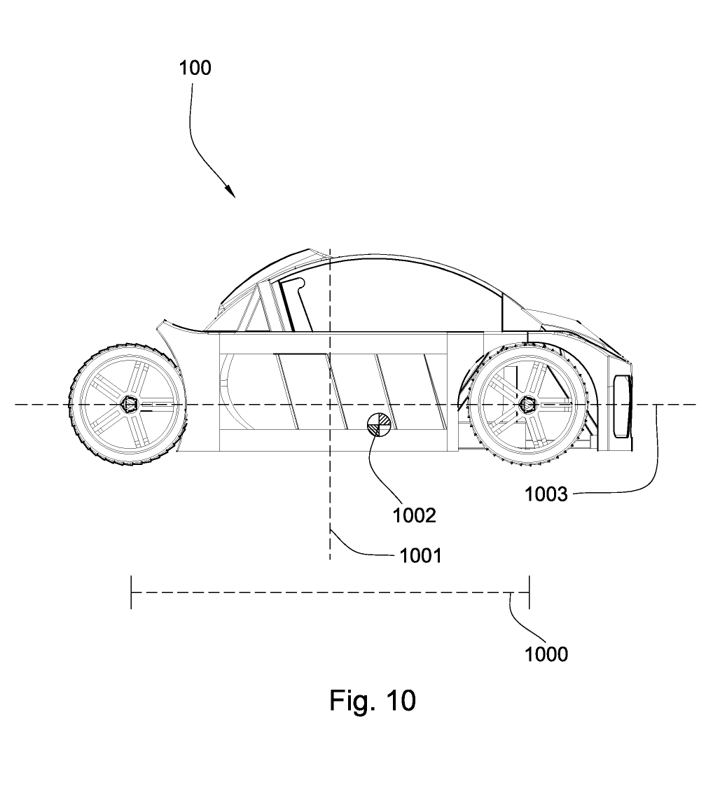

FIG. 10 discloses another embodiment of a vehicle 100. In this embodiment, the vehicle comprises a wheelbase 1000 measured between an axis of rotation of the front wheels and an axis of rotation of the rear wheel. The wheelbase 1000 comprises a midpoint 1001. A center of gravity 1002 of the vehicle 100 may be located forward of the midpoint 1001 of the wheelbase and below a plane 1003 that intersects the axes of rotation of the front and rear wheels. Locating the center of gravity in this manner may improve the dynamic stability of the vehicle. Other methods may be used to improve the dynamic stability of the vehicle, such as electronic traction control and electronic stability control, anti-lock brake systems, or similar systems.

Whereas the present invention has been described in particular relation to the drawings attached hereto, it should be understood that other and further modifications apart from those shown or suggested herein, may be made within the scope and spirit of the present invention.

What is claimed is:

1. A vehicle comprising:
a frame comprising a front portion and a rear portion, with two front wheels steerably attached to the front portion, a swing arm connected to the rear portion of the frame at first and second pivots separated by a first distance, the pivots comprising a common axis of rotation, and a drive wheel attached to a distal end of the swing arm;
the common axis of rotation and the distal end of the swing arm being separated by a second distance;
wherein the first distance is greater than the second distance.

2. The vehicle of claim 1, wherein the drive wheel is in mechanical communication with a rotating drive shaft disposed proximate the rear portion of the frame.

3. The vehicle of claim 2, wherein the rotating drive shaft comprises an axis of rotation coaxial with the common axis of rotation of the pivots.

4. The vehicle of claim 3, wherein the rotating drive shaft comprises a transmission output shaft.

5. The vehicle of claim 4, wherein at least a portion of a transmission is disposed between the first and second pivots.

6. The vehicle of claim 5, wherein the transmission comprises a constantly variable transmission.

7. The vehicle of claim 2, wherein the drive wheel is in mechanical communication with the rotating drive shaft through a chain and sprockets.

8. The vehicle of claim 2, wherein the drive wheel is in mechanical communication with the rotating drive shaft through a belt and pulleys.

9. The vehicle of claim 2, wherein the drive wheel is in mechanical communication with the rotating drive shaft through an intermediate drive shaft.

10. The vehicle of claim 2, wherein the rotating drive shaft is driven by an internal combustion engine.

11. The vehicle of claim 10, wherein the internal combustion engine is disposed proximate the rear portion of the frame.

12. The vehicle of claim 6, wherein the internal combustion engine comprises a four-stroke cycle.

13. The vehicle of claim 6, wherein the internal combustion engine comprises a two-stroke cycle.

14. The vehicle of claim 2, wherein the rotating drive shaft is driven by an electric motor.

15. The vehicle of claim 1, wherein a spring and damper are disposed between a point on the swing arm intermediate the pivot axis and the distal end, and a point on the rear portion of the frame.

16. The vehicle of claim 14, wherein a mechanical linkage is disposed intermediate the spring and damper and the point on the swing arm.

17. The vehicle of claim 1, wherein the vehicle comprises an enclosed passenger compartment.

18. The vehicle of claim 16, wherein the enclosed passenger compartment comprises a deformation resistant roll cage.

19. The vehicle of claim 1, wherein the vehicle comprises a center of gravity disposed below a plane defined by rotational axes of the front wheels and the rear wheel.

20. The vehicle of claim 1, wherein the vehicle comprises a center of gravity disposed forward of a midpoint between the front wheels and rear wheel.
